(19) United States
(12) Patent Application Publication
(10) Pub. No.: US 2008/0005921 A1
(43) Pub. Date: Jan. 10, 2008

(54) DEVICE AND METHOD FOR PRODUCING AND/OR FINISHING A WEB OF FIBROUS MATERIAL

(76) Inventors: Thomas Gruber-Nadlinger, Langenrohr (AT); Gunter Halmschlager, Krems (AT); Christoph Haase, Asperhofen (AT); Herbert Boden, St. Polten (AT); Norbert Karner, Krummnussbaum (AT); Peter Kastner, St. Polten (AT); Gunter Seitlhuber, Herzogenburg (AT); Gerhard Holtmann, St. Polten (AT); Andreas Figerl, Traisen (AT); Rainer Kloibhofer, Neumarkt (AT); Erich Rollenitz, St. Polten (AT)

Correspondence Address: Todd T. Taylor;Taylor & Aust, P.C., 142 S. Main Street, P.O. Box 560, Avilla, IN, 46710, US

(21) Appl. No.: 11/773,725

(22) Filed: Jul. 5, 2007

Related U.S. Application Data
(63) Continuation of application No. PCT/EP05/56144, filed on Nov. 22, 2005.

(30) Foreign Application Priority Data
Jan. 5, 2005 (DE) 10 2005 000 795.3

(51) Int. Cl. F28F 5/02; F26B 11/02; D06F 58/00

(52) U.S. Cl. 34/108; 165/89; 34/124

(57) ABSTRACT

The invention relates to a device and a method for producing and/or transforming a web of fibrous material, in particular a paper or cardboard web. Said device includes a heatable and rotatable cylinder, in particular a drying cylinder of a drying section, and a cylinder sleeve which can be impinged from the inside by a heating fluid. In order to improve the heating power below the external surface of the cylinder sleeve, at least one channel is provided in order to guide the heating fluid.

### CROSS REFERENCE TO RELATED APPLICATIONS

This is a continuation of PCT application No. PCT/EP2005/056144, entitled “DEVICE AND METHOD FOR PRODUCING AND/OR TRANSFORMING A WEB OF FIBROUS MATERIAL”, filed Nov. 22, 2005, which is incorporated herein by reference.

### BACKGROUND OF THE INVENTION

1. Field of the Invention

The present invention relates to a device for producing and/or finishing a web of fibrous material, in particular a paper or paperboard web, having a heatable and rotatable cylinder, in particular a drying cylinder of a drying section, having a cylinder shell which can be loaded from the inside with a heating fluid.

2. Description of the Related Art

A heated cylinder of this type is known from DE 102 60 509.2. In the known cylinder, tensile stresses which are produced because the inner region of the cylinder expands in a more pronounced manner than the outer region are minimized by the fact that the cylinder shell includes at least two shell layers and the material of the outer shell layer has a greater coefficient of thermal expansion at an assembly temperature which lies below the mean operating temperature and a smaller coefficient of thermal expansion at an assembly temperature which lies above the mean operating temperature than the material of the inner shell layer. A further measure consists in that the layer thickness of the outer shell layer is smaller than that of the inner shell layer.

In drying cylinders of this type, a temperature gradient toward the surface is produced during paper drying. The surface temperature of the cylinder is lower than the temperature of the steam, with which the cylinder is heated; the drying capacity is therefore restricted. Increasing the saturated steam temperature is usually not appropriate for economic reasons.

EP 0 559 628 B1 has disclosed a dryer for drying a web of fibrous material, in which dryer a throughflow cylinder is used in conjunction with a blowing hood. The latter is provided with a nozzle arrangement, with the aid of which drying gas jets are applied to the outer surface of the web which is to be dried, while said web is guided around the heated cylinder over a sector of approximately 270° or more. The circumference of the cylinder is provided with a system of channel lines, into which a coolant can be guided from a coolant source. Water in the web is evaporated outward as a result of the drying gas jets and removed via spaces in the blowing hood. Secondly, water from the web condenses on the cooled circumferential surface of the cylinder and is extracted by suction via the perforation in the outer shell of the cylinder and a vacuum which prevails in the interior of the cylinder. The entire inner space of the cylinder is available for receiving the condensate. As a result, the inner wall of the cylinder has to have a certain minimum wall thickness, in order for it to be possible to withstand the pressure loadings in the case of the cylinder diameters which are used.

What is needed in the art is to increase the drying performance of a heatable cylinder.

### SUMMARY OF THE INVENTION

The present invention provides at least one channel for passing the heating fluid through which is formed below the outer surface of the cylinder shell.

As a result of the present invention, the heating fluid can be brought very close to the outer surface of the heatable cylinder. As a result, the temperature gradient is lower than in the case of the known devices of the abovementioned type, and the drying performance is increased accordingly.

According to a refinement of the invention, in order to form the at least one channel, a further cylinder shell which is spaced apart from the outer cylinder shell is arranged within the cylinder shell. This can be achieved satisfactorily in structural terms and has the advantage that the entire inner side of the outer cylinder shell can be loaded with heating fluid.

According to a further refinement of the invention, the outer cylinder shell is supported on the inner cylinder shell. As a result, the wall thickness of the outer cylinder shell can be kept small, as the inner cylinder shell acts as a carrying cylinder. As a result, the drying performance can be increased still further.

In order to support the outer cylinder shell on the inner cylinder shell, in particular webs, rods, pins, rivets, bolts, screws and/or other connecting ways can be provided. It is important that the connecting ways are distributed over the surface of both cylinder shells, in order to ensure uniform support.

The webs or other connecting elements can extend axially, in the circumferential direction and/or in a direction which lies between them. In all cases, satisfactory support can be achieved.

In particular in the case of webs which extend in the circumferential direction, it is advantageous if they are provided at least partially with passage openings for the heating fluid. The heating fluid can then flow not only in the circumferential direction but also in the longitudinal direction of the drying cylinder.

The inner shell and the outer shell can be composed of the same or of a different material. In any case, it is advantageous if it is a metallic material, as satisfactory thermal conduction and sufficient stability are then ensured.

As material, in particular, for the outer shell, material having high thermal conductivity can be used. In particular, steel, such as boiler steel, copper, aluminum or bronze, may be suitable. Satisfactory thermal transmission onto the web of fibrous material can therefore be ensured.

The configuration of the inner cylinder as a thick-walled tube is advantageous in structural terms. A satisfactory carrying property is therefore also ensured.

The inner cylinder can also include two or more individual shells. As a result, the thermal expansion behavior and the loadability can be improved.

However, the inner cylinder can also be configured as a framework or as a frame/rib construction. This can also be advantageous in specific applications.

According to a further refinement of the invention, the inner side of the outer cylinder shell is provided with elevations. As a result, the condensate which collects on the inner side of the outer cylinder shell is subjected to turbulence, as a result of which the thermal transfer is improved. The condensate which collects namely has a thermally insulating effect and increases the temperature gradient to the cylinder surface.

According to a refinement of the invention, the inner side of the outer cylinder shell face is configured with ribs and/or lugs and/or a grid or honeycomb structure. Satisfactory swirling of the condensate can therefore be achieved.

The height of the elevations on the inner side of the outer cylinder shell can be selected in such a way that they protrude out of the fluid condensate which is formed during operation. In this way, the elevations have direct contact with the heating fluid, as a result of which the heat can be transferred in an improved manner to the outer surface of the drying cylinder. Moreover, the increase in the surface area as a result of the elevations has a positive effect on the heat transfer. Elevations having a smaller height than the height of the condensate are therefore also advantageous.

The elevations can extend in the cylinder longitudinal direction and/or along a helical line. A special conveying action for condensate discharge can be achieved by a helical line.

According to one refinement of the invention, one or more siphons is/are provided for discharging condensate which is formed during operation. They can be configured such that they are stationary or co-rotate with the drying cylinder. The condensate quantity which collects on the inner side of the outer cylinder shell can be reduced as a result.

The outer surface of the drying cylinder can be provided with a coating or covering. The latter serves, in particular, for corrosion or abrasion protection or for improving the surface, for example in order to avoid adhesion of paper.

According to one special refinement of the invention, web plates which are connected to the inner cylinder shell are provided as connecting elements between the inner and outer cylinder shells. The outer cylinder shell can be formed by covering plates which are likewise connected to the web plates.

In another special refinement of the invention, the web plates and covering plates are combined to form profiles, preferably U-shaped or T-shaped.

According to another special refinement of the invention, the outer shell and the connecting elements are manufactured in one piece, in particular by welding, milling from a tube, casting or by way of other manufacturing processes.

The outer cylinder shell and the inner cylinder shell can advantageously be connected to one another by a press fit. Another possibility includes a screwed connection. Moreover, a conical seat or a form-fitting connection, in particular an L-connection, T-connection or dovetail connection, is advantageous. In order to produce play in the connection, a soldering material can additionally be attached, which melts during subsequent heating of the cylinder and then hardens again. However, the tolerances can also be selected in such a way that there is no play.

Other possibilities for connection include clamping elements, a self-locking or a latching connection. Combinations of all abovementioned connections are also possible, for example a T-groove connection with a conical seat or a T-groove connection with screws.

According to a further refinement of the invention, the inner cylinder shell is formed from individual metal sheets which are connected to the connecting elements and to one another in a suitable manner, for example welding. Both the inner cylinder shell and the outer cylinder shell can also be manufactured in this way.

According to a further special refinement of the invention, bolts are provided as connecting elements between the inner and outer cylinder shells, which bolts are introduced into holes in the outer cylinder shell and are connected to the inner cylinder shell, for example by rotary friction welding or resistance pressure welding or by screwing in. The connection of the bolt and the outer cylinder shell in the holes can take place subsequently, for example by welding. Instead of bolts which are introduced into holes of the outer cylinder shell, bolts can also be provided which are introduced into holes of the inner cylinder shell and are then connected to the outer cylinder shell.

According to a further refinement of the invention, the inner cylinder shell and the outer cylinder shell can be manufactured in each case in one piece over their entire length, for example by casting.

According to another refinement of the invention, only one cylinder shell is provided which is configured as a thick-walled tube and in which channels for the heating fluid are made, for example by deep-hole drilling or milling. In this way, the heating fluid can also be brought close to the outer surface of the drying cylinder and the drying performance can therefore be increased.

In another refinement of the invention, the inner cylinder shell and the connecting elements are manufactured as one piece, to which the outer shell is then fastened by way of a suitable process.

One advantageous connecting type results if the webs between the inner cylinder shell and the outer cylinder shell are divided obliquely over their height. That is to say, one part web is provided in each case on the inner cylinder shell and one part web is provided on the outer cylinder shell. By rotation of the inner and outer cylinder shells with respect to one another, said web parts are brought into connection with one another and a force-transmitting connection is produced.

In order to feed in and discharge the heating fluid, corresponding channels can be provided in the axle of the drying cylinder. The feed channel and the return channel can be nested inside one another here. This saves space and simplifies the construction.

The heating fluid can be distributed onto the hollow space between the inner and outer cylinder shells via radial channels, in particular at least in the cover on the feed side. This is particularly advantageous when, as viewed over the circumference, a large number of individual channels are arranged next to one another, for example in the case of continuous webs in the longitudinal direction of the drying cylinder between the inner and the outer cylinder shells or in the case of a drilled single shell.

Moreover, it can be advantageous to turn the outer shell face. As a result, a smooth surface can be achieved.

The elevations on the inner side of the outer cylinder shell can be milled, drawn, pressed, rolled or cast. Other manufacturing types are also possible.

The webs, metal sheets or other connecting elements between the inner and outer cylinder shells can be manufactured by removing material, by primary forming technology or by forming technology. A combination of these processes is also possible.

An apparatus of the abovementioned type can be used for producing a web of fibrous material, in particular a paper or paperboard web. Here, a drying cylinder of the abovementioned type or a plurality of drying cylinders of this type can be used. A drying cylinder according to the present invention can also be combined with conventional drying cylinders.

During production, contact with the web of fibrous material can be made by the drying cylinders in each case on the same side. However, contact on both sides is also possible. Depending on the application, one or the other variant is advantageous.

All known auxiliary devices can be used for web guidance, for example a suction or blower box, an evacuated or nonevacuated roll, an airblade or a dryer fabric.

In particular, cylinder drying, the boost dryer process, the Condebelt process, a yankee cylinder and a HiDryer may be suitable as conventional drying processes.

Together with the web of fibrous material and optionally a felt, a metal belt can also be guided over the drying cylinder. The latter can be cooled and under stress. As a result, the temperature gradient over the web of fibrous material can be increased and rapid removal of the moisture can therefore be achieved.

The drying performance can be increased by the method according to the invention and the device according to the invention. As a result, a finished dried paper can be achieved with a relatively low dwell time. This can be utilized firstly by the fact that less space is required in comparison with a drying section according to the prior art, which results in savings in the basic price, the building costs for the hall, the machine frames and the fume extraction hood, and also the operating costs for drives and hood ventilation. Secondly, this can be utilized by the fact that a speed increase is achieved with existing space conditions, for example papermaking machine conversions, with an identical length of the drying section. As a result, the papermaking machine can be operated more economically. Moreover, the steam pressure can be reduced with the same drying performance. For example, the differential steam pressure could be utilized for electricity generation, or the energy for steam generation can be minimized.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a longitudinal section through a drying cylinder of a device according to the invention;

FIG. 2 shows a partial plan view of the end side of the drying cylinder of FIG. 1;

FIG. 3 shows a partial cross section through a drying cylinder of a device according to the invention;

FIG. 4 shows a variant of FIG. 3;

FIG. 5 shows a further variant of FIG. 3;

FIG. 6 shows a partial longitudinal section through a drying cylinder of a device according to the invention;

FIG. 7 shows a variant of FIG. 6; and

FIG. 8 shows a simplified longitudinal section through a further drying cylinder of a device according to the invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

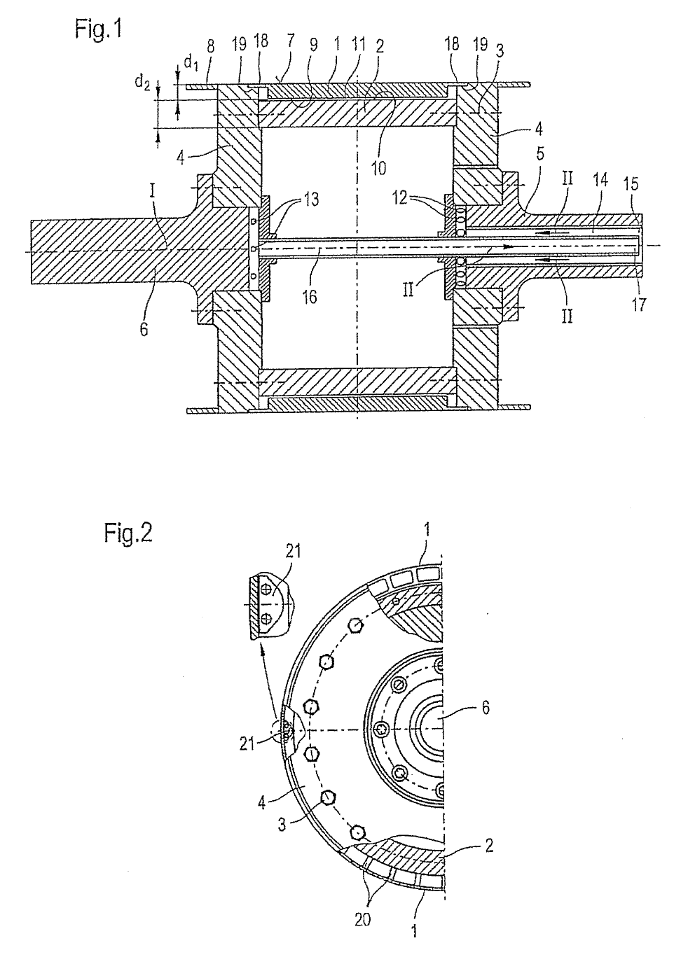

Referring now to the drawings, and more particularly to FIG. 1, there is shown a drying cylinder in the drying section of a papermaking machine. The drying cylinder includes an outer cylinder shell 1 and an inner cylinder shell 2 which is arranged concentrically in the former. The inner cylinder shell 2 is fastened via screws 3 to two end-side covers 4 which are of disk-shaped configuration and in each case have one bearing axle 5, 6. The drive side is situated on the left-hand side in FIG. 1, and the operator side of the drying cylinder is situated on the right-hand side.

The outer cylinder shell 1 has an outer surface 7, over which a paper web which is to be dried is guided. The outer surface 7 of the outer cylinder shell 1 is of flush configuration with the circumferential faces 8 of the two covers 4. As a result, a continuous contact face for the paper web is provided.

The outer cylinder shell 1 has a thickness d₁ which is smaller than the thickness d₂ of the inner cylinder shell 2. The inner circumferential face 9 of the outer cylinder shell 1 is at a spacing from the outer circumferential face 10 of the inner cylinder shell 2, with the result that an annular hollow space 11 is formed between the outer cylinder shell 1 and the inner cylinder shell 2. This annular space 11 is connected to radial channels 12, 13 in the two axles 5, 6 of the covers 4 on both end sides of the two cylinder shells 1, 2 via channels (not shown here) in the covers 4. For their part, the radial channels 12 of the axle 5 of the operator-side cover 4 are connected to an axial channel 14 which is provided centrally in the axle 5 of the operator-side cover 4 and opens in a connection end 15. The radial channels 13 of the axle 6 of the drive-side cover 4 are likewise connected to an axial channel 16. Starting from the drive-side cover 4, said channel 16 is guided concentrically with respect to the rotational axis I of the drying cylinder centrally through the two cylinder shells 1, 2 and the axle 5 of the operator-side cover 4, and likewise opens in a connection end 17. Here, the channel 16 penetrates the channel 14 concentrically, with the result that the channel 14 has an annular cross section.

The above-described construction results in a channel system which makes the circulation of heating fluid possible through the hollow space 11 between the outer cylinder shell 1 and the inner cylinder shell 2. For this purpose, for example, heating fluid is fed into the annular channel 14 via the connection end 15. From there, the heating fluid passes via the radial channels 12 into the channels (not shown) in the operator-side cover 4 and, from the latter, into the hollow space 11 between the outer cylinder shell 1 and the inner cylinder shell 2. The heating medium then flows from the operator side through the hollow space 11 to the drive-side and passes there via the channels (not shown) in the drive-side cover 4 into the radial channels 13 of the drive-side axle 6. From there, the heating fluid in turn flows via the central channel 16 back to its connection end 17.

On both end sides, the outer cylinder shell 1 has in each case tapered sections 18, with which the outer cylinder shell 11 rest in each case on a corresponding seat 19 on the circumferential sides of the covers 4. As a result, the outer cylinder shell 1 is supported on the two covers 4. However, the main support of the outer cylinder shell 1 takes place over its length by way of connecting elements 20, as are shown by way of example in FIG. 2 and which are distributed over the circumferential faces of the outer cylinder shell 1 and the inner cylinder shell 2. Moreover, FIG. 2 also shows a siphon 21 which is provided for removing condensate at the end-side end of the hollow space 11. Siphons 21 of this type can be provided both on the drive side and on the operator side and are of either co-rotating or stationary configuration. A plurality of siphons of this type can also be provided in the circumferential direction.

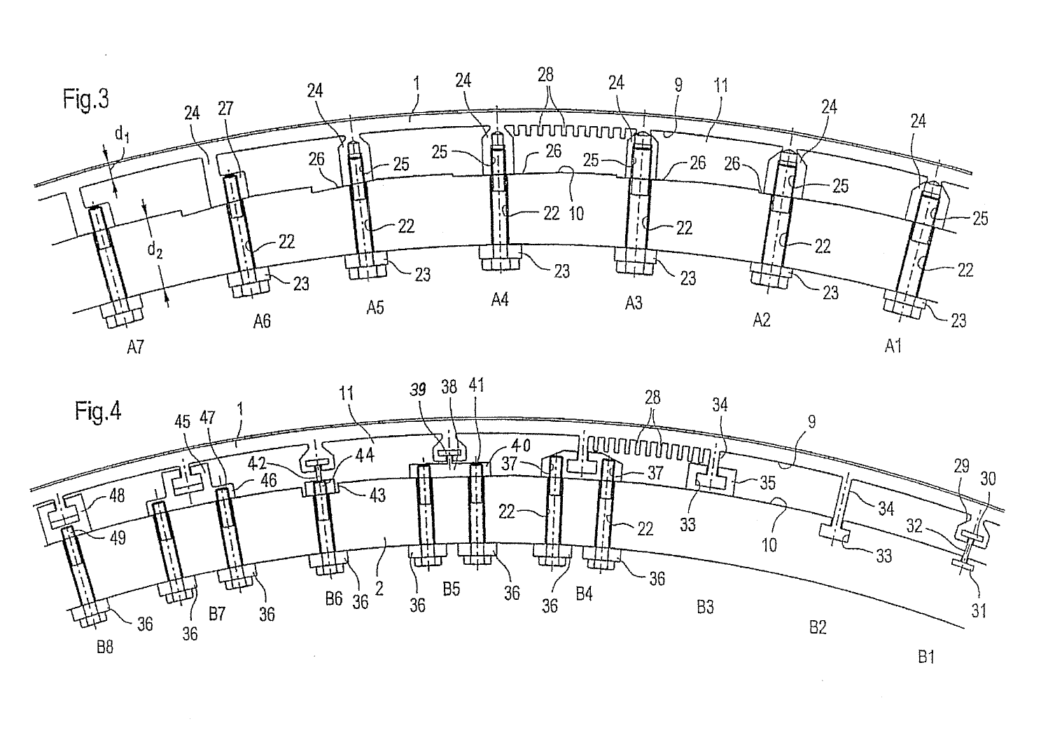

Different variants of the connecting elements 20 between the outer cylinder shell 1 and the inner cylinder shell 2 are shown in FIGS. 3 to 5 and will be described in the following text.

FIGS. 3 to 5 show a circumferential section of a drying cylinder according to the invention having an outer cylinder shell 1 of small thickness d₁ and an inner cylinder shell 2 of greater thickness d₂ in comparison. There is a hollow space 11 for guiding a heating fluid through between the outer cylinder shell 1 and the inner cylinder shell 2.

At A1 in FIG. 3, a screwed connection is shown between the outer cylinder shell 1 and the inner cylinder shell 2. For this purpose, the inner cylinder shell 2 has holes 22, through which screws 23 are guided. Lying opposite the holes 22 in the inner cylinder shell 2, the outer cylinder shell 1 has radially inwardly pointing projections 24, in which threaded holes 25 are provided, into which the screws 23 can be screwed. The outer cylinder shell 1 is supported on the inner cylinder shell 2 via the radial projections 24, and the screws 23 fix the two cylinder shells 1, 2 with respect to one another. A radial projection can be provided in each case only in the case of the screws 23 or can extend continuously in the axial direction of the drying cylinder or in another direction.

At A2, a similar connection is shown between the inner cylinder shell 2 and the outer cylinder shell 1. The only difference is that here, lying opposite the radial projection 24, in each case one tangentially milled seat 26 is provided on the outer circumferential face 10 of the inner cylinder shell 2. As a result, improved support can be achieved.

At A3, a connection is shown which largely corresponds to the connection of A2. The only difference is that the diameter of the screw holes 22 and the screws 23 is smaller here than the corresponding diameters at A2. For example, screws of the size M10 can be used at A2 and screws of the size M8 can be used at A3. The smaller screws save weight in comparison with the larger screws.

A further variant of the connection of A3 is shown at A4. The difference is that the seat 26 here is not milled tangentially but at an angle of 2° with respect to the tangential direction. The milling serves to clamp the outer cylinder shell 1 with respect to the inner cylinder shell 2. For this purpose, after it has been fed onto the inner cylinder shell 2, the outer cylinder shell is rotated in the direction of the rising seat 26, that is to say to the right in FIG. 3 about the axis I of the drying cylinder.

A stronger clamping action is realized in the connection which is shown at A5. Here, the angle of the milling is 5° with respect to the tangential direction. Otherwise, this connection corresponds to the connection of A4.

In the variant which is shown at A6, there is in turn a seat 26 which is milled at 5° with respect to the horizontal direction. However, the radial projection 24 of the outer cylinder shell 1 is not of straight configuration as in the above-described variants, but has an L-shape. The base 27 of the L-shaped projection 24 is supported here on the milled seat 26. As a result, the support becomes more stable.

It is shown at A7 that an L-shaped projection 24 can also be combined with a seat 26 which is milled at 0° or a seat 26 which is milled at 10°.

Finally, it is shown in FIG. 3 that the outer cylinder shell 1 can be provided with elevations 28 on its inner circumferential face 9. These serve to impart turbulence to the collecting condensate, in order to improve the thermal conductivity to the outer surface 7 of the outer cylinder shell 1. In addition to the shape which is shown, other shapes are also possible. The height of the elevations 28 can be selected in each case in such a way that they protrude at least to a certain extent from the condensate, in order that they can be loaded directly by the heating medium and therefore bring about satisfactory additional thermal conduction to the outer surface 7 of the outer cylinder shell 1.

FIG. 4 shows different variants of the form-fitting connection between the outer cylinder shell 1 and the inner cylinder shell 2. As shown at B1, the outer cylinder shell 1 can be provided for this purpose on its shell inner side 9 with projections 29 which extend in the axial direction or another direction and in which T-shaped grooves 30 are provided which open toward the inner cylinder shell 2. Corresponding T-shaped grooves 31 which open toward the outer cylinder shell 1 are provided in the outer surface 10 of the inner cylinder shell 2. Via I-beams 32 which are inserted into the grooves 30, 31, a form-fitting connection is then effected between the outer cylinder shell 1 and the inner cylinder shell 2, which form-fitting connection at the same time brings about support of the outer cylinder shell 1 on the inner cylinder shell 2. Here, the I-beams 32 can have such an external dimension that a play results between them and the T-grooves 30, 31, in particular a rearward and lateral play. Assembly takes place by pushing the I-shaped beams 32 into the grooves 30, 31 after the outer cylinder shell 1 has been pushed onto the inner cylinder shell 2.

In the variant which is shown at B2, likewise T-shaped grooves 33 are provided in the outer surface 10 of the inner cylinder shell 2. However, projections 34 of T-shaped cross section on the shell inner side 9 of the outer cylinder shell 1 engage into them. Assembly takes place here by simply pushing the outer cylinder shell 1 onto the inner cylinder shell 2. The connection can also be configured with or without play here.

Like the groove 31 in the above-described variant, the groove 33 can be milled into the outer surface 10 of the inner cylinder shell 2. However, other production processes are also possible.

The variant which is shown at B3 differs from the variant which is shown at B2 in that the groove 33 for receiving the projection 34 of T-shaped cross section is not milled into the outer surface 10 of the inner cylinder shell 2 but is formed by a corresponding groove profile 35 being welded on. The projection 34 is of correspondingly shorter configuration and is supported on the outer surface 10 of the inner cylinder shell 2 via the groove profile 35. The connection can also be configured here with rearward and lateral play. In comparison with the variant of B1, no groove is therefore required here in the inner cylinder shell 2.

The variant of B4 corresponds largely to the variant of B3. The difference is only in that the groove profiles 35 are not welded to the inner cylinder shell 2 but are screwed via screws 36. For this purpose, the groove profiles 35 have lateral threaded holes 37.

The variant which is shown at B5 is distinguished by the fact that profiles 38 are screwed onto the outer circumferential side 9 of the inner cylinder shell 2, which profiles 38 have, on their radial outer side, a section 39 of T-shaped cross section which can be introduced into the groove 30 of a projection 29 which corresponds in principle to the projection 29 which is shown at B1. For this purpose, screws 36 are screwed into corresponding threaded holes 41 which are provided in lateral flanges 40 of the profile 38. In this variant, there can also be rearward and lateral play between the T-section 39 and the groove 30.

The variant which is shown at B6 is similar to the variant which is shown at B5. Instead of the profile 38, a T-profile 42 is provided here, which is inserted into a groove 43 on the outer side 10 of the inner cylinder shell 2. Moreover, for fastening of the profile 42, only one row of screws 36 are inserted into corresponding threaded holes 44 of the profile 42.

The variant which is shown at B7 corresponds largely to the variant of B4. Here, however, the groove profile 45 is configured with two in each case outwardly pointing flanges 46, in which in each case threaded holes 47 are provided for screwing in the screws 36. Moreover, the groove profile 45 is moved more closely to the inner surface 9 of the outer cylinder shell 1, with the result that the projection 34 of T-shaped cross section is correspondingly shorter.

The variant which is shown at B8 in turn corresponds largely to the variant of B3. Here, however, the groove profile 48 is not welded to the inner cylinder shell 2 but is connected via screws 36 again. For this purpose, the groove profile 48 has corresponding threaded holes 49 on its side which faces the inner cylinder shell 2. Here, as in the variant of B7, the groove profile 48 is also moved closer to the inner surface 9 of the outer cylinder shell 1 and interacts with projections 34 of correspondingly shorter configuration on the inner side 9 of the outer cylinder shell 1.

In the form-fitting variants which are shown in FIG. 4, elevations 28 for generating turbulence in the condensate which is formed can also be provided on the inner side 9 of the outer cylinder shell 1. The elevations 28 can again have all possible shapes and orientations, but preferably protrude from the condensate to a small extent.

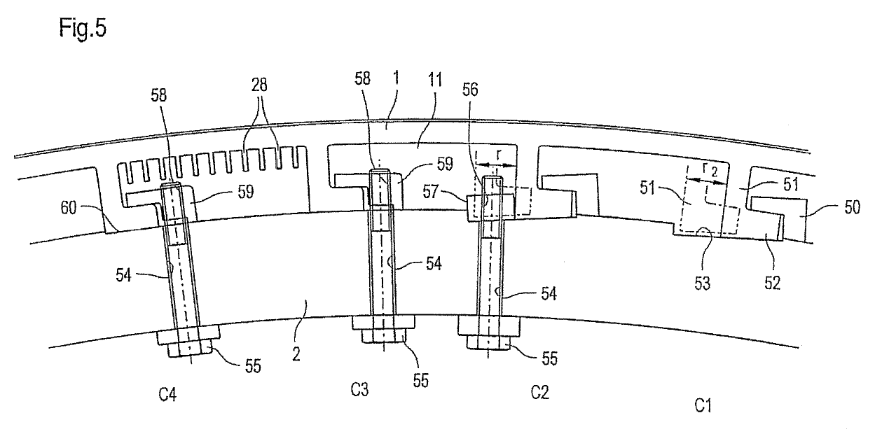

FIG. 5 shows four further form-fitting variants. At C1, one variant is shown, in which an angled profile 50 is welded to the outer upper side 10 of the inner cylinder shell 2. A projection 51 of L-shaped cross section which is formed integrally on the inner side 9 of the outer cylinder shell 1 interacts with this angled profile 50. The base 52 of the profile 51 engages under the angled profile 50 and is supported on the seat 53 which is milled at 5° on the outer side 10 of the inner cylinder shell 2. Corresponding profiling of the projection 51 results in a self-locking connection between the outer cylinder shell 1 and the inner cylinder shell 2.

For assembly, the outer cylinder shell 1 is pushed axially onto the inner cylinder shell 2 in the position of the projection 51 which is shown with dashed lines at C1. The outer cylinder shell 1 is then rotated with respect to the inner cylinder shell 2 in the direction of the angled profile 50, that is to say to the right in FIG. 5, about the axle of the drying cylinder by the spacing r₂, with the result that the projection 51 engages under the angled profile 50 by way of its base 52 and is fixed in a self-locking manner.

The variant which is shown at C2 corresponds largely to the variant of Cl. Instead of the self-locking profiling of the projection 51, only a screwed connection is provided here for fixing the outer cylinder shell 1 with respect to the inner cylinder shell 2. For this purpose, the inner cylinder shell 2 is provided with holes 54, through which screws 55 are guided which can be screwed into threaded holes 56 which are provided in extensions 57 which are provided at suitable spacings in the axial direction on that side of the projection 51 which faces away from the base 52 of the L-shaped projection 51. The assembly takes place in a corresponding manner to the variant of C1, only the screws 55 also being screwed in after rotation of the two cylinder shells 1, 2 with respect to one another.

In the variant which is shown at C3, the two cylinder shells 1, 2 are also fixed with respect to one another via screws 55. However, in a difference from the variant of C2, these are screwed into threaded holes 58 here which are provided in the angled profile 59 which is connected to the inner cylinder shell 2. Moreover, in this variant, there is no milled seat on the outer side 10 of the inner cylinder shell 2.

There is a milled seat of this type in turn in the variant which is shown at C4. This seat 60 is milled tangentially in this variant. Otherwise, this variant corresponds to the variant of C3. In both variants of C3 and C4, the assembly takes place by rotation of the outer cylinder shell 1 with respect to the inner cylinder shell 2 after the outer cylinder shell 1 has been pushed on and the screws 55 have subsequently been screwed in, in accordance with the variant of C2.

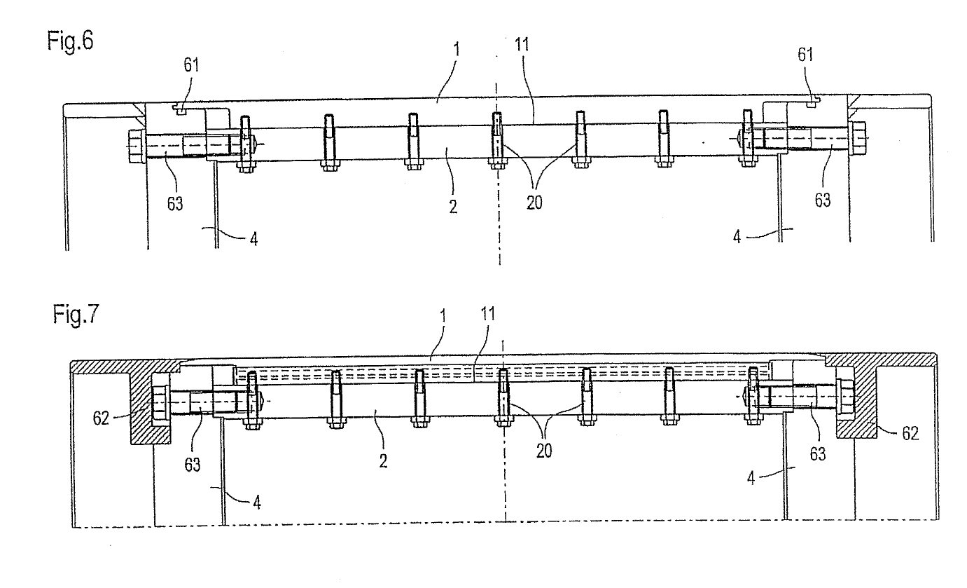

The partial longitudinal section of FIG. 6 once again generally shows the connection and support of the outer cylinder shell 1 to or on the inner cylinder shell 2 via connecting elements 20 which are represented here as screws. In order to seal the hollow space 11 between the inner cylinder shell 2 and the outer cylinder shell 1 to the outside, sealing rings 61 are provided between said outer cylinder shell 1 and the covers 4 in the circumferential faces of the covers 4. Sealing to the inside is not required in principle.

In the variant which is shown in FIG. 7 and which otherwise corresponds to the variant of FIG. 6, seals 62 are provided instead of the sealing rings 61, which seals 62 engage around the screws 63, by way of which the covers 4 are fastened to the inner cylinder shell 2. As a result, improved sealing to the outside can be ensured.

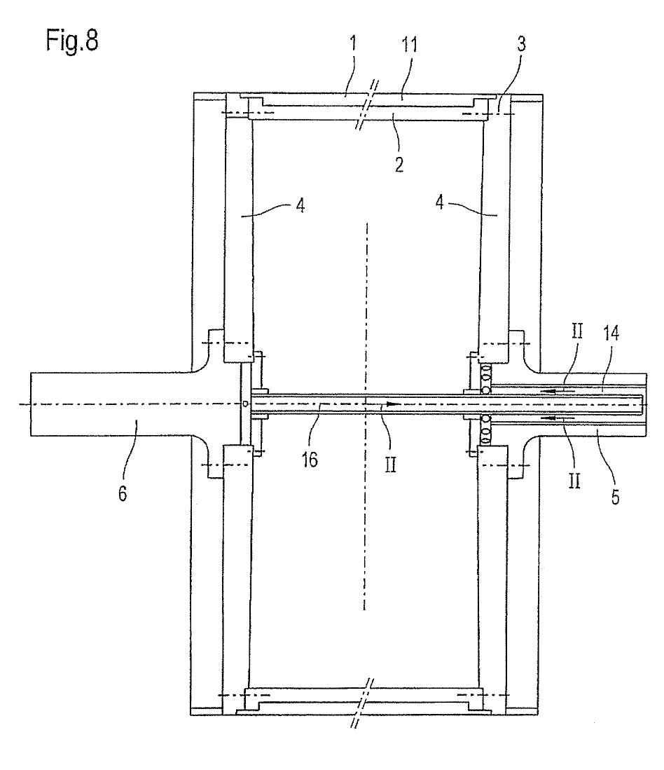

Finally, FIG. 8 once again shows in simplified form the construction of the drying roll in its entirety with an outer cylinder shell 1 and an inner cylinder shell 2 which is fastened to the two covers 4 which are in turn arranged on axles 5, 6. The operator-side axle 5 has the radial channels 12 and the concentric axial channels 14 and 15; the drive-side axle 6 likewise has radial channels 1. The connecting channels are also not shown here between the radial channels 12 and 13 and the hollow space 11 between the outer cylinder shell 1 and the inner cylinder shell 2. The flow direction of the heating fluid is shown by way of arrows II.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF DESIGNATIONS

1 Outer cylinder shell

2 Inner cylinder shell

3 Fastening screw

4 Cover

5 Operator-side axle

6 Drive-side axle

7 Outer side of 1

8 Circumferential face of 4

9 Inner side of 1

10 Outer side of 2

11 Hollow space

12 Radial channel

13 Radial channel

14 Axial channel

15 Connection end of 14

16 Axial channel

17 Connection end of 16

18 Tapered section of 1

19 Seat

20 Connecting element

21 Siphon

22 Hole

23 Screw

24 Projection

25 Threaded hole

26 Seat

27 Base of 24

28 Elevation

29 Projection

30 Groove

31 Groove

32 I-beam

33 Groove

34 Projection

35 Groove profile

36 Screw

37 Threaded hole

38 Profile

39 T-section of 38

40 Flange

41 Threaded hole

42 T-profile

43 Groove

44 Threaded hole

45 Groove profile

46 Flange

47 Threaded hole

48 Groove profile

49 Threaded hole

50 Angled profile

51 Projection

52 Base of 51

53 Seat

54 Hole

55 Screw

56 Threaded hole

57 Extension

58 Threaded hole

59 Angled profile

60 Seat

61 Annular seal

62 Seal

63 Screw

I Rotational axis

II Flow direction

d₁ Thickness of 1

d₂ Thickness of 2

r Spacing

r₂ Spacing

What is claimed is:

1. A device for at least one of producing and finishing a web of fibrous material comprising:
a heatable and rotatable drying cylinder of a drying section, said drying cylinder including a first cylinder shell configured for being loaded from an inside with a heating fluid, said first cylinder shell including an outer surface below which is formed at least one channel for passing said heating fluid through.

2. The device as claimed in claim 1, wherein said drying cylinder includes an inner cylinder shell, said first cylinder shell being an outer cylinder shell, said inner cylinder shell being spaced apart from said outer cylinder shell and being arranged within said outer cylinder shell so as to form said at least one channel.

3. The device as claimed in claim 2, wherein said outer cylinder shell is supported on said inner cylinder shell.

4. The device as claimed in claim 2, wherein said outer cylinder shell is connected to said inner cylinder shell using a plurality of connecting elements.

5. The device as claimed in claim 4, wherein said plurality of connecting elements includes at least one of a plurality of radial webs, a plurality of rods, a plurality of pins, a plurality of rivets, a plurality of bolts, and a plurality of screws.

6. The device as claimed in claim 5, wherein said plurality of radial webs at least partially has a plurality of passage openings for said heating fluid.

7. The device as claimed in claim 4, wherein said plurality of connecting elements one of extends and is arranged axially in at least one of a circumferential direction and a direction which lies between said plurality of connecting elements.

8. The device as claimed in claim 4, wherein said plurality of connecting elements between said outer cylinder shell and said inner cylinder shell includes a plurality of web plates.

9. The device as claimed in claim 8, wherein said outer cylinder shell includes a plurality of covering plates.

10. The device as claimed in claim 9, wherein said plurality of covering plates are combined with said plurality of web plates to form a plurality of profiles.

11. The device as claimed in claim 9, wherein said plurality of profiles includes one of a plurality of U-shaped profiles and a plurality of T-shaped profiles.

12. The device as claimed in claim 4, wherein said outer cylinder shell and said plurality of connecting elements are one piece.

13. The device as claimed in claim 12, wherein said outer cylinder shell and said plurality of connecting elements are manufactured in said one piece by one of welding, milling from a tube, and casting.

14. The device as claimed in claim 4, wherein said plurality of connecting elements between said outer cylinder shell and said inner cylinder shell includes a plurality of clamping elements.

15. The device as claimed in claim 4, wherein said plurality of connecting elements are self-locking.

16. The device as claimed in claim 2, wherein said inner cylinder shell and said outer cylinder shell include one of a same and a different metallic material.

17. The device as claimed in claim 2, wherein at least one of said outer cylinder shell and said inner cylinder shell includes a material having a high thermal conductivity.

18. The device as claimed in claim 17, wherein said material having said high thermal conductivity includes one of steel, copper, aluminum, and bronze.

19. The device as claimed in claim 18, wherein said steel includes a boiler steel.

20. The device as claimed in claim 2, wherein said inner cylinder shell includes a thick-walled tube.

21. The device as claimed in claim 2, wherein said inner cylinder shell includes at least two individual shells.

22. The device as claimed in claim 2, wherein said inner cylinder shell includes one of a framework construction and a frame and rib construction.

23. The device as claimed in claim 2, wherein said outer cylinder shell includes an inner side including a plurality of elevations.

24. The device as claimed in claim 23, wherein said inner side of said outer cylinder shell includes at least one of a plurality of ribs, a plurality of lugs, and one of a grid and a honeycomb structure.

25. The device as claimed in claim 23, wherein said plurality of elevations includes a height such that said plurality of elevations are configured for protruding out of a fluid condensate formed during operation.

26. The device as claimed in claim 25, wherein said plurality of elevations are configured for protruding out of said fluid condensate as little as possible.

27. The device as claimed in claim 23, wherein said plurality of elevations at least one of extends in a cylinder longitudinal direction and is helical.

28. The device as claimed in claim 2, further comprising at least one siphon configured for discharging a condensate formed during operation.

29. The device as claimed in claim 28, wherein at least one said siphon includes at least one of at least one stationary siphon and at least one co-rotating siphon.

30. The device as claimed in claim 2, wherein said outer surface of said drying cylinder includes one of a coating and a covering.

31. The device as claimed in claim 30, wherein one of said coating and said covering is configured at least one of for protecting against at least one of corrosion and abrasion and for improving a plurality of surface properties.

32. The device as claimed in claim 2, wherein said outer cylinder shell and said inner cylinder shell form a connection therebetween including a plurality of screws.

33. The device as claimed in claim 2, wherein said outer cylinder shell and said inner cylinder shell form a connection therebetween including a conical seat.

34. The device as claimed in claim 2, wherein said outer cylinder shell and said inner cylinder shell form a first connection therebetween including a form-fitting connection.

35. The device as claimed in claim 34, wherein said form-fitting connection includes one of an L-groove connection, a T-groove connection, and a dovetail connection.

36. The device as claimed in claim 34, wherein said first connection includes a soldered connection.

37. The device as claimed in claim 34, wherein said first connection is configured without play.

38. The device as claimed in claim 2, wherein said outer cylinder shell and said inner cylinder shell form a connection therebetween including a press fit.

39. The device as claimed in claim 2, wherein said outer cylinder shell and said inner cylinder shell form a connection therebetween including a latching connection.

40. The device as claimed in claim 2, wherein said inner cylinder shell includes a plurality of individual metal sheets.

41. The device as claimed in claim 40, wherein said plurality of individual metal sheets includes a welded connection between said plurality of individual metal sheets.

42. The device as claimed in claim 2, wherein said outer cylinder shell and said inner cylinder shell are manufactured in each case from one piece.

43. The device as claimed in claim 2, wherein said outer cylinder shell is connected to said inner cylinder shell using a plurality of connecting elements which includes a plurality of bolts, said outer cylinder shell defining a plurality of holes, said plurality of bolts being guided through said plurality of holes in said outer cylinder shell and being connected to said inner cylinder shell.

44. The device as claimed in claim 43, wherein said plurality of bolts are connected to said inner cylinder shell one of by rotary friction welding, by resistance pressure welding, and by screwing in.

45. The device as claimed in claim 2, wherein said outer cylinder shell and said inner cylinder shell are manufactured in each case in one piece respectively over an entire length of said outer cylinder shell and an entire length of said inner cylinder shell.

46. The device as claimed in claim 45, wherein said outer cylinder shell and said inner cylinder shell are manufactured by casting.

47. The device as claimed in claim 2, wherein said outer cylinder shell is connected to said inner cylinder shell using a plurality of connecting elements, said inner cylinder shell and said plurality of connecting elements forming one piece.

48. The device as claimed in claim 2, wherein said outer cylinder shell is connected to said inner cylinder shell using a plurality of connecting elements which include a plurality of webs divided obliquely over a height of said plurality of webs.

49. The device as claimed in claim 2, wherein said drying cylinder includes a plurality of cylinder axles configured for feeding in and discharging said heating fluid.

50. The device as claimed in claim 49, wherein said plurality of axles includes at least one feed channel and at least one discharge channel which are nested inside one another at least partially.

51. The device as claimed in claim 2, wherein said drying cylinder includes a feed side and a cover on said feed side, said cover having a plurality of radial channels for said heating fluid.

52. The device as claimed in claim 2, wherein said outer surface of said drying cylinder is turned.

53. The device as claimed in claim 2, wherein said outer cylinder shell includes an inner side including a plurality of elevations which are one of milled, drawn, pressed, rolled, and cast.

54. The device as claimed in claim 2, wherein said outer cylinder shell is connected to said inner cylinder shell using a plurality of connecting elements, said plurality of connecting elements being manufactured one of by removing material, by primary forming technology, and by forming technology.

55. The device as claimed in claim 1, wherein said drying cylinder includes a thick-walled tube including a plurality of fluid channels which includes said at least one channel.

56. The device as claimed in claim 55, wherein said plurality of fluid channels are made by one of deep-hole drilling and milling.

57. A method for producing a web of fibrous material comprising the steps of:
providing a device for at least one of producing and finishing the web of fibrous material, said device including a heatable and rotatable drying cylinder of a drying section, said drying cylinder including a cylinder shell which includes an outer surface below which is formed at least one channel;
loading said cylinder shell from an inside with a heating fluid; and
passing said heating fluid through said at least one channel.

58. The method as claimed in claim 57, wherein said drying cylinder includes one of a single drying cylinder and a plurality of drying cylinders.

59. The method as claimed in claim 58, wherein one of said single drying cylinder and said plurality of drying cylinders is combined with at least one conventional drying process.

60. The method as claimed in claim 59, wherein said at least one conventional drying process includes at least one of cylinder drying, a boost dryer process, a Condebelt process, a yankee cylinder, and a HiDryer.

61. The method as claimed in claim 57, further comprising the step of always making contact with the web of fibrous material on a same side.

62. The method as claimed in claim 57, further comprising the step of making contact with the web of fibrous material on both sides.

63. The method as claimed in claim 57, further comprising the step of guiding the web of fibrous material with an auxiliary device.

64. The method as claimed in claim 63, wherein said auxiliary device includes at least one of one of a suction box and a blower box, one of an evacuated roll and a nonevacuated roll, an airblade, and a dryer fabric.

65. The method as claimed in claim 57, further comprising the step of guiding a metal belt with the web of fibrous material over said drying cylinder.

66. The method as claimed in claim 65, wherein said metal belt is cooled.

67. The method as claimed in claim 65, wherein said metal belt is guided over said drying cylinder under stress.
